(19) United States
(12) Patent Application Publication
(10) Pub. No.: US 2005/0066348 A1
(43) Pub. Date: Mar. 24, 2005

(54) Laser-marked data medium

(75) Inventor: Isabelle Limousin, Cadolive (FR)

Correspondence Address: BURNS DOANE SWECKER & MATHIS L L P, POST OFFICE BOX 1404, ALEXANDRIA, VA, 22313-1404, US

(73) Assignee: GEMPLUS, Genemos (FR)

(21) Appl. No.: 10/498,225

(22) PCT Filed: Dec. 13, 2002
(86) PCT No.: PCT/FR02/04339

(30) Foreign Application Priority Data
Dec. 14, 2001 (FR) 01/16840

(51) Int. Cl. G11B 7/24; B32B 3/02; G11B 3/70; G11B 5/84; G11B 7/26; G11B 23/03

(52) U.S. Cl. 720/718; 369/288; 428/64.4

(57) ABSTRACT

A laser marked data medium includes a plastic material substrate coated with a visible wavelength transparent film. The substrate contains a first marking pigment. The transparent film contains a second marking pigment, which is an absorber of laser wavelengths.

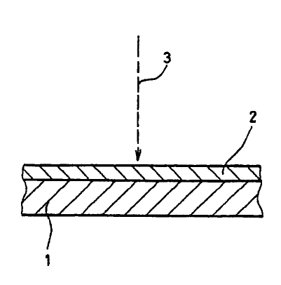

The present invention relates to a laser-marked data medium.

It concerns more precisely a laser-marked data medium comprising a substrate made of plastic material, the substrate being coated with a layer transparent to visible wavelengths, the substrate containing a first marking pigment.

A data medium of this type is known from the patent documents EP 0 987 121 and WO 95/34263.

Such a data medium often consists of a card whose substrate consists of injected ABS with a filler of titanium dioxide and is coated with a layer of varnish transparent to visible wavelengths.

This substrate is generally of a specific white colour by virtue of the concentration of titanium dioxide, which is a white pigment. Titanium dioxide is also a laser-marking pigment becoming black under YAG laser (yttrium aluminium garnet laser) radiation of wavelength equal to 1024 nm. Data are therefore currently produced on such a card by laser radiation and ionisation of the titanium dioxide contained in the substrate and creation of a blue-grey plasma.

However, in view of the requirement of specific white colouring of the substrate, the titanium dioxide concentration in the substrate is fixed and cannot easily be modified and it turns out that this marking is of inadequate quality, grey in colour. This is detrimental to the aesthetics of the card and can also lead to serious usage problems, for example in the case of bar codes printed in this way.

Searching for compositions of ABS and pigment in the substrate can be envisaged in order to solve this problem of lack of contrast of the data. However, as a general rule, the card manufacturer and the manufacturer of raw material for the substrate are different and the first is therefore dependent upon the second for such modifications.

Furthermore, on this substrate there is deposited a layer transparent to visible wavelengths consisting of a varnish serving as protection for the printing, giving a glossy and aesthetic appearance and capable of allowing personalisation of the card.

The present invention solves this problem of lack of contrast of the data carried by such media without modification of the raw material of the substrate.

To do this, in accordance with the invention, the transparent layer contains a second marking pigment, this pigment absorbing the wavelengths of the laser.

Preferably, the first pigment is titanium dioxide.

And advantageously, the second pigment is chosen from amongst TiO₂, Nb₂O₃, Sb₂O₃, WO₃, ZnO, Cu₂O and ZnS.

Preferably, the plastic material of the substrate is an ABS matrix.

Preferably, the layer transparent to visible wavelengths consists of an acrylate matrix.

According to one specific embodiment, the concentration by weight of titanium dioxide in the substrate is between 4% and 8% and the second pigment is TiO₂ with a concentration by weight in the layer transparent to visible wavelengths of between 4% and 7% or WO₃ with a concentration by weight in the layer transparent to visible wavelengths of between 4% and 12%.

The invention is described hereinafter in more detail with reference to a figure according to a preferred embodiment.

A substrate 1 consists of a matrix of ABS, namely poly(acrylonitrile butadiene styrene), a pigment which is an insoluble substance having a high covering and opacifying power, namely titanium dioxide which is a high-performance white pigment with good thermal stability, and a filler which is an insoluble substance with a low covering and opacifying power, for example CaCO₃, BaSO₄, MgO, Al₂O₃ or SiO₂.

The matrix can also be made of polystyrene or PET.

This substrate 1 is coated with a layer 2 of material transparent to visible wavelengths, namely a varnish consisting of acrylate. This varnish also contains a marking pigment. In order to retain the transparency of the varnish, this pigment is transparent and can be Nb₂O₃, Sb₂O₃, WO₃, ZnO or titanium dioxide in very low concentration.

The concentration by weight of titanium dioxide in the ABS matrix of the substrate 1 is between 4% and 8%. The concentration by weight of marking pigment in the acrylate matrix of the varnish 2 is between 4% and 12% depending on the pigment taking into account the necessary compromise between marking and transparency of the transparent layer.

Advantageously, the second pigment is TiO₂ with a concentration by weight in the layer transparent to visible wavelengths of between 4% and 7%, in view of the white colour of the TiO₂, or WO₃ with a concentration by weight in the layer transparent to visible wavelengths of between 4% and 12%.

By laser radiation 3 of the surface of the layer of varnish 2, three mechanisms take place:
absorption of the laser radiation by the pigments of the substrate 1 and of the varnish 2;
generation of heat due to conversion of the absorbed energy and diffusion of the heat in the substrate 1 and the varnish 2;
ionisation by ablation of surface electrons and creation of electron-hole pairs and creation of plasma by recombination and emission of colour.

The pigment contained in the transparent surface layer 2 consequently acts on two levels: after absorption of the laser radiation, it transmits absorbed energy to the titanium dioxide of the substrate 1 reinforcing the black marking action thereof and is itself ionised increasing the marking by its own creation of black colour.

Marking of a dark high-quality black is thus obtained.

1. A laser-marked data medium comprising a substrate made of plastic material and containing a first marking pigment, and a layer coated on said substrate which is transparent to visible wavelengths and which contains a second marking pigment absorbs the wavelengths of a laser.

2. A data medium according to claim 1, wherein said first pigment is titanium dioxide.

3. A data medium according to claim 2, wherein said second pigment is chosen from amongst TiO₂, Nb₂O₅, Sb₂O₃, WO₃, ZnO, Cu₂O and ZnS.

4. A data medium according to claim 1, wherein said plastic material of the substrate is an ABS matrix.

5. A data medium according to claim 1, wherein said layer transparent to visible wavelengths comprises an acrylate matrix.

6. A data medium according to claim 2, wherein the concentration by weight of titanium dioxide in the substrate is between 4% and 8%.

7. A data medium according to claim 3, wherein said second pigment is TiO₂ with a concentration by weight in said layer transparent to visible wavelengths of between 4% and 7%.

8. A data medium according to claim 3, wherein said second pigment is WO₃ with a concentration by weight in said layer transparent to visible wavelengths of between 4% and 12%.

9. A data medium according to claim 1, wherein said second pigment is chosen from amongst TiO₂, Nb₂O₅, Sb₂O₃, WO₃, ZnO, Cu₂O and ZnS.

10. A data medium according to claim 9, wherein said second pigment is TiO₂ with a concentration by weight in said layer transparent to visible wavelengths of between 4% and 7%.

11. A data medium according to claim 9, wherein said second pigment is WO₃ with a concentration by weight in said layer transparent to visible wavelengths of between 4% and 12%.
